(19) United States
(12) Patent Application Publication
(10) Pub. No.: US 2018/0245861 A1
(43) Pub. Date: Aug. 30, 2018

(54) HEAT EXCHANGER

(71) Applicant: Mahle International GmbH, Stuttgart (DE)

(72) Inventors: Jorge Curras-Guede, Ostifldern (DE); Pramod Patil, Sangli (IN); Cyril Stock, Stuttgart (DE)

(73) Assignees: Mahle International GmbH, Stuttgart (DE); Mahle International GmbH, Stuttgart (DE)

(21) Appl. No.: 15/755,055

(22) PCT Filed: Aug. 24, 2015
(86) PCT No.: PCT/EP2015/069373

§ 371 Date: Feb. 23, 2018

(51) Int. Cl. F28F 9/02; B60H 1/32

(52) U.S. Cl. CPC F28F 9/0251; F28F 2275/122; F28F 9/0224; B60H 1/3227

(57) ABSTRACT

A heat exchanger may include a plurality of tubes each having longitudinal ends and held at the longitudinal ends in a collector. The collector may include a first element and a second element. The first element may include a plurality of passage openings for receiving the plurality of tubes. The second element may include at least one slot extending in a longitudinal direction of the second element. The heat exchanger may also include at least one attachment flange including two inner lips facing toward the at least one slot, a first duct section communicating with the at least one slot, and a second duct section angled relative to the first duct section by an angle β. The two inner lips may bear on and be calked against an edge of the at least one slot.

### CROSS-REFERENCE TO RELATED APPLICATIONS

This application claims priority to International Patent Application No. PCT/EP2015/069373, filed on Aug. 24, 2015, the contents of which are hereby incorporated by reference in its entirety.

### TECHNICAL FIELD

The present invention relates to a heat exchanger having flat tubes which are each held at the left-hand ends in a collector. The invention also relates to a motor vehicle having at least one such heat exchanger.

### BACKGROUND

In order to enable heat exchangers, in particular condensers, to be positioned in motor vehicles under ever more constricted installation space conditions, it is increasingly necessary for attachment flanges thereof to be of angled design. Such attachment flanges are normally mounted onto an edge on corresponding passage openings on the collector and calked with or brazed to said edge. The collectors themselves are normally assembled from a first and a second element, wherein the first element, for example, is in the form of a tube plate and has passage openings for the individual tubes, in particular for flat tubes. The second element, which is for example in the form of a half-shell, likewise has a passage opening with the abovementioned upturned edge, onto which the attachment flange is mounted. If it is now desired to realize an orientation of the passage opening for the attachment flange and of the passage openings for the tubes which is rotationally shifted about a longitudinal axis of the collector, this has hitherto only been possible by way of a rotationally shifted connection of the two elements to one another, which however has the result that only limited angular positions can be realized. An angle between the axis of the passage opening of the attachment flange and the axis of the passage openings for the tubes of greater than 30°, for example, is conventionally not possible.

Furthermore, attachment flanges are provided which have a Z-shaped duct configuration and which can be mounted on conventional, non-rotationally shifted passage openings. The production of such Z-shaped attachment flanges is however cumbersome and, in any case, requires an additional closure plug which seals off a bore duct in the attachment flange at the end side. Said additional closure plug however constitutes an additional component which not only has to be installed but also has to be stocked and managed logistically. A particular disadvantage in the case of such a Z-shaped attachment flange is however also the resulting relatively large pressure drop, which increases a flow resistance of the heat exchanger.

### SUMMARY

The present invention is therefore concerned with the problem of specifying, for a heat exchanger of the generic type, an improved or at least alternative embodiment which is cheaper, and more favorable with regard to a pressure drop, than hitherto known Z-shaped attachment flanges.

Said problem is solved according to the invention by way of the subject matter of the independent claim(s). The dependent claims relate to advantageous embodiments.

The present invention is based on the general concept that, instead of a hitherto circular passage opening for the attachment of an attachment flange, a slot-shaped passage opening is now provided for the first time, and at the same time, the attachment flange is designed such that it can be calked with an edge of said slot. Furthermore, a central point (axis) perpendicular to the passage opening of the slot is oriented at an angle with respect to the axis of the passage openings for the tubes or flat tubes. Here, the heat exchanger according to the invention has the stated tubes which are each held at the longitudinal ends in a collector, wherein said collector is assembled from two elements, specifically a first element and a second element, said elements in particular being brazed together. In this case, passage openings in the form of rim holes for receiving the tubes are provided in the first element. According to the invention, on the second element, there is provided at least one slot which extends in the longitudinal direction of said second element, as well as an attachment flange which has two inner lips facing toward the slot and preferably at least one outer lip, wherein, in the assembled state, the outer lip bears on the outer surface of the second element whereas the inner lips bear on and are calked against an edge of the slot. According to an advantageous embodiment, an axis of the slot on the first element deviates by an angle α from an axis of a passage opening which is formed as a rim hole in the first element. By means of a collector or heat exchanger designed in this way, it is possible for an attachment flange to be positioned in a much more flexible manner, and in particular for said attachment flange to also be of cheaper design, as it no longer imperatively has to be in the form of a Z-shape attachment flange and furthermore equipped with a closure plug. In this way, the number of individual parts required is reduced. At the same time, the outlay in terms of machine processing of the attachment flange can be reduced. It is however particularly advantageous that, by comparison with a Z-shape attachment flange, a pressure drop can be considerably reduced, whereby the flow resistance of the heat exchanger according to the invention can be reduced, and thus the performance thereof increased.

The attachment flange expediently has a first duct section, which communicates with the slot, and a second duct section, which is angled relative to said first duct section by an angle β. Depending on the size of the angle β, it is thus possible to realize a second duct section which is angled to virtually any desired degree, and thus an attachment which is angled to virtually any desired degree, for example of an attachment hose, whereby increased flexibility can be achieved.

In a further advantageous embodiment of the solution according to the invention, the angles α and β are equal, such that the second duct section runs parallel to the tubes. Through the selection of the angles α and β, it is thus possible for the first duct section to assume virtually any desired angle with respect to the flat tube or with respect to the tubes in general, said angle being compensated again by the angle β such that, if the two angles α and β are equal, the second duct section always runs parallel to the tubes. In this way, it is possible to realize a parallel second duct section for attachment to, for example, a hose, wherein, in relation to a Z-shaped attachment flange hitherto used for this purpose, the attachment flange according to the invention is not only considerably cheaper but also has a considerably lower flow resistance and thus a considerably lower pressure drop.

In a further advantageous embodiment of the solution according to the invention, the inner lips bear on and are bent around an edge of the slot. Aside from a purely calked connection, it is thus also possible for the inner lips to be bent around the edge of the slot, whereby particularly reliable fixing of the attachment flange to the second element of the collector is made possible.

The edge of the at least one slot is expediently turned up in an inward direction. In the case of such an edge which is turned up in an inward direction, it is possible to provide a larger surface area for the calking of the inner lip with the edge, whereby improved connection of the attachment flange to the second element of the collector is made possible. In the case of brazing, it is possible here, too, to realize a braze surface, whereby particularly reliable sealing can be achieved. The attachment flange is in this case normally brazed to the second element, wherein a brazed seam runs both between the outer lips of the attachment flange and the second element and between the inner lips and the edge of the second element. In addition to the calking or crimping of the inner lip with the edge of the passage opening, it is thus possible to achieve a particularly well-sealed connection of the attachment flange to the second element of the collector.

The present invention is furthermore based on the general concept of equipping a motor vehicle with at least one such heat exchanger, wherein such a heat exchanger may for example be designed as a condenser. By means of the heat exchanger according to the invention, which is cheaper than previous heat exchangers, it is thus also possible for the production costs for the motor vehicle to be indirectly positively influenced, that is to say reduced.

Further important features and advantages of the invention will emerge from the subclaims, from the drawings and from the associated description of the figures on the basis of the drawings.

It is self-evident that the features mentioned above and the features yet to be discussed below may be used not only in the respectively specified combination but also in other combinations or individually without departing from the scope of the present invention.

Preferred exemplary embodiments of the invention are illustrated in the drawings and will be discussed in more detail in the following description, wherein the same reference signs are used to denote identical or similar or functionally identical components.

### BRIEF DESCRIPTION OF THE DRAWINGS

In the drawings, in each case schematically:

FIG. 1 shows a heat exchanger with a Z-shaped attachment flange in section, as per the prior art,

FIG. 2 is a further sectional illustration through a collector of a heat exchanger as per the prior art, with a straight attachment flange,

FIG. 3 shows an attachment flange according to the invention,

FIG. 4 is a sectional illustration through the attachment flange according to the invention, in a state in which said attachment flange is attached to a collector,

FIG. 5 is an illustration as in FIG. 4, but in the case of a different embodiment,

FIG. 6 shows a sectional view of the attachment flange,

FIG. 7 shows a sectional view of the attachment flange illustrated in FIG. 5,

FIG. 8 shows a plan view of FIG. 9, and

FIG. 9 shows a side view of FIG. 8.

### DETAILED DESCRIPTION

Below, reference signs are followed by an apostrophe (′) where they relate to the embodiment as per the prior art. Reference signs without an apostrophe relate to the embodiment according to the invention.

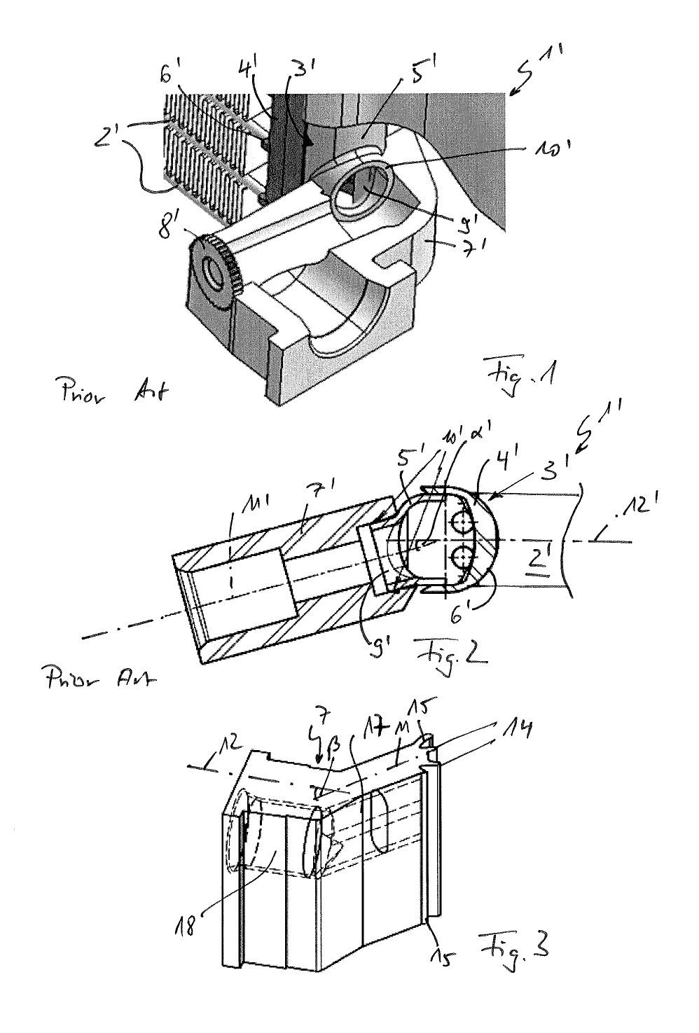

As per FIG. 1, a heat exchanger 1′ has tubes 2′ which are each held at the longitudinal ends in a collector 3′. In this case, the collector 3′ is assembled from two elements 4′, 5′, wherein passage openings 6′ for receiving the tubes 2′ are provided in the form of rim holes in the first element 4′. Also provided is an attachment flange 7′ (cf. also FIG. 2) by means of which the collector 3′ is connected to a refrigerant supply path or a refrigerant discharge path.

Viewing the attachment flange 7′ as per the prior art from FIG. 1, it can be seen that said attachment flange is of Z-shaped form and is closed off by means of a closure plug 8′. A disadvantage of the attachment flange 7′ known from the prior art as per FIG. 1 is its relatively high pressure drop and the associated high flow resistance and the relatively cumbersome and thus expensive manufacture of the attachment flange 7′. The high manufacturing costs arise in particular from the cumbersome production and installation of the closure plug 8′ which must furthermore be stocked as a separate part for installation. The attachment flange 7′ itself is in this case folded over a circular edge 10′ of the passage opening 9′. The attachment flange 7′ is brazed and thus sealingly connected to said edge 10′.

Viewing the heat exchanger 1′ known from the prior art as per FIG. 2, it can be seen that an axis 11′ of the attachment flange 7′ is angled by an angle α′ with respect to an axis 12′ of a passage opening 6′ which is arranged in the first element 4′ and which is in the form of a rim hole. The angle α′ by which the attachment flange 7′ can be angled is however limited in this case.

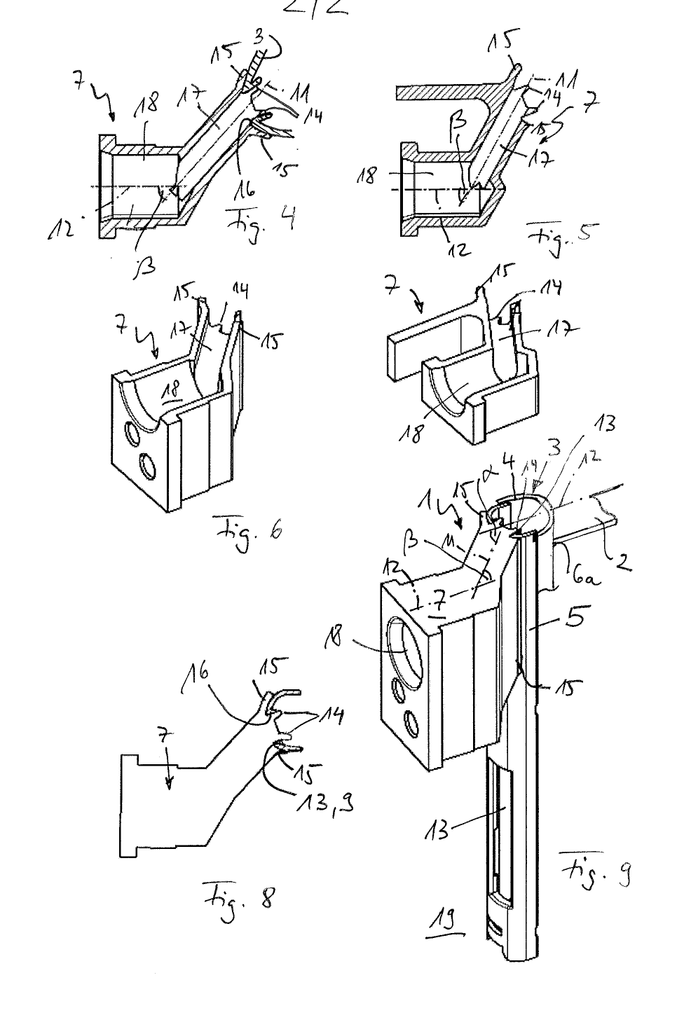

Viewing the heat exchanger 1 according to the invention (cf. FIG. 9), it can be seen that, on the second element 5, there is provided at least one slot 13 which extends in the longitudinal direction of said second element. Likewise provided is an attachment flange 7 according to the invention which has two inner lips 14 facing toward the slot 13 and at least one outer lip 15 (cf. also FIGS. 3 and 5-9), wherein it is self-evidently also possible for two outer lips 15 to be provided (cf. FIG. 3), and wherein, in the assembled state (cf. FIG. 3), the at least one outer lip 15 (cf. FIGS. 8 and 9) or the two outer lips 15 bear on the outer surface of the second element 5 whereas the inner lips 14 bear on and are calked against an edge 16 of the slot 13. In this case, an axis 11 of the slot 13 deviates by an angle α from an axis 12 of the passage opening 6, which is formed as a rim hole in the first element 4, for the tubes 2, in particular flat tubes 2.

Here, the attachment flange 7 according to the invention is considerably cheaper to produce than the attachment flange 7′ known from the prior art (cf. FIG. 1), not only because it is easier to manufacture but additionally because it is also possible to dispense with the closure plug 8′ that has hitherto been required. In this way, not only the variety of parts and the associated storage and logistics costs but also the assembly costs are reduced. A major advantage in the case of the attachment flange 7 according to the invention is however its considerably improved flow resistance and thus its considerably reduced pressure drop in relation to the Z-shaped attachment flange 7′ known from the prior art.

Considering the attachment flange 7 according to the invention further, it can be seen that said attachment flange has a first duct section 17, which communicates with the slot 13, and a second duct section 18, which is angled relative to said first duct section by an angle β. In this case, the first duct section 17 has a slot-shaped cross section, whereas the second duct section 18 has a circular cross section. Here, it is preferable for the two angles α and β to be equal, such that the second duct section 18 runs parallel to the axis 12 of the tubes 2.

In a particularly preferred embodiment of the solution according to the invention, the inner lips 14 bear on and are additionally bent around an edge 16 of the slot 13. Such an embodiment is however not illustrated in the figures in this case. The edge 16 of the slot 13 may in this case additionally be turned up in an inward direction (cf. FIG. 3), or else may be turned up neither in an inward nor in an outward direction and thus may be produced by way of a simple punching process. In general, the heat exchanger 1 according to the invention may be designed as a condenser in a motor vehicle 19. To be able to achieve as well-sealed a connection as possible between the attachment flange 7 and the second element 5, said two components 7, 5 are brazed to one another, whereby sealing is made possible in addition to the calking of the inner lips 14 with the edge 16 of the slot 13.

By means of the heat exchanger 1 according to the invention and the attachment flange 7 designed according to the invention, it is thus possible to realize considerably increased flexibility with regard to an angled connection, wherein, by comparison with the attachment flange 7′ known from the prior art, it is possible to realize a considerable reduction in a flow resistance and thus a considerably reduced pressure drop. Furthermore, at least by comparison with the attachment flange 7′ known from FIG. 1, it is possible to realize a considerably reduced variety of parts and, in association therewith, considerably reduced production costs.

1. A heat exchanger, comprising:
a plurality of tubes each having longitudinal ends and held at the longitudinal ends in a collector;
the collector including a first element and a second element, the first element including a plurality of passage openings for receiving the plurality of tubes, the second element including at least one slot extending in a longitudinal direction of the second element;
at least one attachment flange including two inner lips facing toward the at least one slot, a first duct section communicting with the at least one slot, and a second duct section angled relative to the first duct section by an angle β;
wherein the two inner lips bear on and are calked against an edge of the at least one slot.

2. The heat exchanger as claimed in claim 1, wherein the at least one attachment flange further includes at least one outer lip, wherein, in an assembled state, the at least one outer lip bears on an outer surface of the second element.

3. The heat exchanger as claimed in claim 1, wherein an axis of the at least one slot deviates by an angle α from an axis of a passage opening of the plurality of passage openings structured as a rim hole in the first element.

4. (canceled)

5. The heat exchanger as claimed in claim 1, wherein the first duct section has a slot-shaped cross section, and wherein the second duct section has a circular cross section.

6. The heat exchanger as claimed in claim 5, wherein an axis of the at least one slot deviates by an angle α from an axis of a passage opening of the plurality of passage openings structured as a rim hole in the first element, and wherein the angles α and β are equal, such that the second duct section extends parallel to the plurality of tubes.

7. The heat exchanger as claimed in claim 1, wherein the two inner lips bear on and are bent around the edge of the at least one slot.

8. The heat exchanger as claimed in claim 1, wherein the edge of the at least one slot is turned up in an inward direction.

9. The heat exchanger as claimed in claim 1, wherein the heat exchanger is a condenser.

10. The heat exchanger as claimed in claim 1, wherein the at least one attachment flange is brazed to the second element.

11. A motor vehicle, comprising:
at least one heat exchanger including:
a plurality of tubes each having longitudinal ends and held at the longitudinal ends in a collector;
the collector including a first element and second element, the first element including a plurality of passage openings for receiving the plurality of tubes, the second element including at least one slot extending in a longitudinal direction of the second element;
at least one attachment flange including two inner lips facing toward the at least one slot, a first duct section communicating with the at least one slot, and a second duct section angled relative to the first duct section by an angle β;
wherein the two inner lips bear on and are calked against an edge of the at least one slot.

12. The motor vehicle as claimed in claim 11, wherein the at least one attachment flange further includes at least one outer lip, wherein, in an assembled state, the at least one outer lip bears on an outer surface of the second element.

13. The motor vehicle as claimed in claim 11, wherein an axis of the at least one slot deviates by an angle α from an axis of a passage opening of the plurality of passage openings structured as a rim hole in the first element.

14. The motor vehicle as claimed in claim 11, wherein the first duct section has a slot-shaped cross section, and wherein the second duct section has a circular cross section.

15. The motor vehicle as claimed in claim 14, wherein an axis of the at least one slot deviates by an angle α from an axis of a passage opening of the plurality of passage openings structured as a rim hole in the first element, and wherein the angles α and β are equal, such that the second duct section extends parallel to the plurality of tubes.

16. The motor vehicle as claimed in claim 11, wherein the two inner lips bear on and are bent around the edge of the at least one slot.

17. The motor vehicle as claimed in claim 11, wherein the edge of the at least one slot is turned up in an inward direction.

18. The motor vehicle as claimed in claim 11, wherein the heat exchanger is a condenser.

19. The motor vehicle as claimed in claim 11, wherein the at least one attachment flange is brazed to the second element.

20. The motor vehicle as claimed in claim 11, wherein an axis of the at least one slot deviates by an angle α from an axis of a passage opening of the plurality of passage openings structured as a rim hole in the first element, and wherein the angles α and β are equal, such that the second duct section extends parallel to the plurality of tubes.

21. The heat exchanger as claimed in claim 1, wherein an axis of the at least one slot deviates by an angle α from an axis of a passage opening of the plurality of passage openings structured as a rim hole in the first element, and wherein the angles α and β are equal, such that the second duct section extends parallel to the plurality of tubes.
